(19) United States
(12) Patent Application Publication
(10) Pub. No.: US 2004/0143592 A1
(43) Pub. Date: Jul. 22, 2004

(54) Method for processing redundant packets in computer network equipment

(76) Inventor: Philippe Jung, Grenoble (FR)

Correspondence Address: WAGNER, MURABITO & HAO LLP, Third Floor, Two North Market Street, San Jose, CA, 95113, US

(21) Appl. No.: 10/670,901

(22) Filed: Sep. 24, 2003

(30) Foreign Application Priority Data
Sep. 30, 2002 (FR) 0212076

(51) Int. Cl. G06F 17/00

(52) U.S. Cl. 707/102

(57) ABSTRACT

A method for processing redundant packets. An incoming packet comprising a source address and data is received. The source address of the incoming packet is searched for in at least a portion of memory. If the source address is found in the portion of memory, a packet identifier based is determined based on the data comprised in the incoming packet. The packet identifier is searched for in at least a portion of a database. If the packet identifier is not found in the portion of the database, the packet identifier is stored in the portion of the database.

### RELATED APPLICATION

This application claims priority to the French Patent Application, Number 0212076, filed on Sep. 30, 2002, in the name of Sun Microsystems, Inc., which application is hereby incorporated by reference.

### FIELD OF INVENTION

Embodiments of the present invention pertain to the field of computer network equipment. More particularly, embodiments of the present invention pertain to a method for filtering redundant packets in computer network equipment.

### BACKGROUND OF THE INVENTION

In typical computer network equipment, computer workstations or nodes are interconnected through a network medium or link. The link may have to be at least partially duplicated to meet reliability constraints. This duplication is called link redundancy. It is now assumed by way of example that data are exchanged between the nodes in the form of packets. Considering a given packet sent from a source node to a destination node, redundancy means that two or more copies of that packet are sent to the destination node through two or more different networks, respectively. The copies of the packet will usually reach the destination node at different times. Thus, the first of the packets is processed normally in the destination node. When the other copy or copies (e.g., redundant packets) arrive, they are processed in a manner which may depend on the transport protocol and/or the user application.

The Transmission Control Protocol (TCP) has a built-in capability to suppress redundant packets. However, this built-in capability involves potentially long and unpredictable delays. On another hand, the User Datagram Protocol (UDP) has no such capability. Accordingly, in UDP, suppressing redundant packets is a task for user applications.

### SUMMARY OF THE INVENTION

Various embodiments of the present invention, a method and system thereof for processing redundant packets, are described herein. In one embodiment, an incoming packet comprising a source address and data is received. The source address of the incoming packet is searched for in at least a portion of memory. If the source address is found in the portion of memory, a packet identifier based is determined based on the data comprised in the incoming packet. The packet identifier is searched for in at least a portion of a database. If the packet identifier is not found in the portion of the database, the packet identifier is stored in the portion of the database.

In one embodiment, it is determined whether a time condition for the incoming packet is satisfied. If the packet identifier is found in the portion of the database and the time condition is satisfied, the incoming packet is identified as a redundant packet and the packet identifier is removed from the portion of the database. If the packet identifier is found in the portion of the database and the time condition is not satisfied, the packet identifier is stored in the portion of the database. In one embodiment, the packet identifier and an arrival time of the incoming packet are stored in the portion of the database.

In one embodiment, whether the time condition is satisfied is determined by comparing a current time with the arrival time to determine an age of the packet identifier, and comparing the age to a given time period in order to determine if the time condition is satisfied. In one embodiment, comparing the age to the given time period is determined by determining that the time condition is satisfied if the age is greater than the given time period, removing the packet identifier and the arrival time; and replacing the packet identifier with a new packet identifier of the incoming packet and replacing the arrival time with a new arrival time associated with the incoming packet

In one embodiment, the time period is customized for incoming packets comprising the same source address. In one embodiment, the time period associated with a source is updated according to the rate of incoming packets from the source.

In one embodiment, first value based on the packet identifier is determined. In one embodiment, the first value is determined according to a hash function.

In one embodiment, the packet identifier is stored in the portion of the database by comparing current time with stored arrival times corresponding to the other packet identifiers to determine ages of the packet identifiers if the portion is full of other packet identifiers, determining an oldest packet identifier of the other packet identifiers, and deleting the oldest packet identifier and its corresponding arrival time.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates a general diagram of a telecommunication network system upon which embodiments in accordance with the invention may be implemented.

FIG. 2 illustrates block diagram of a group of stations or nodes interconnected through two different links, in accordance with an embodiment of the present invention.

FIG. 3 illustrates a block diagram of an exemplary node upon which embodiments in accordance with the invention may be implemented.

FIG. 4A illustrates an exemplary format of an IPv4 header in a packet in accordance with an embodiment of the present invention.

FIG. 4B illustrates an exemplary format of an IPv6 header in a packet in accordance with an embodiment of the present invention.

FIG. 5 illustrates a flow chart showing steps in a process for packet transmission in redundant mode, in accordance with an embodiment of the present invention.

FIG. 6 illustrates a flowchart showing steps in a process for reception of redundant packets, in accordance with an embodiment of the present invention.

FIG. 7 illustrates the structure of an exemplary filtering function, in accordance with an embodiment of the present invention.

FIG. 8 illustrates a flow chart showing steps of a process for discriminating of received packets, in accordance with an embodiment of the present invention.

FIG. 9 illustrates a source node table of a receiving node in accordance with an embodiment of the present invention.

FIG. 10 illustrates an exemplary database of a receiving node in accordance with an embodiment of the present invention.

FIG. 11 illustrates an exemplary data structure, in accordance with an embodiment of the present invention.

### DETAILED DESCRIPTION

As they may be cited in this specification, Sun, Sun Microsystems, Solaris, ChorusOS are trademarks of Sun Microsystems, Inc. SPARC is a trademark of SPARC International, Inc.

For purposes of the present application, making reference to software entities imposes certain conventions in notation. For example, in the detailed description, italics and/or quotes may be used when deemed necessary for clarity to designate specific software functions.

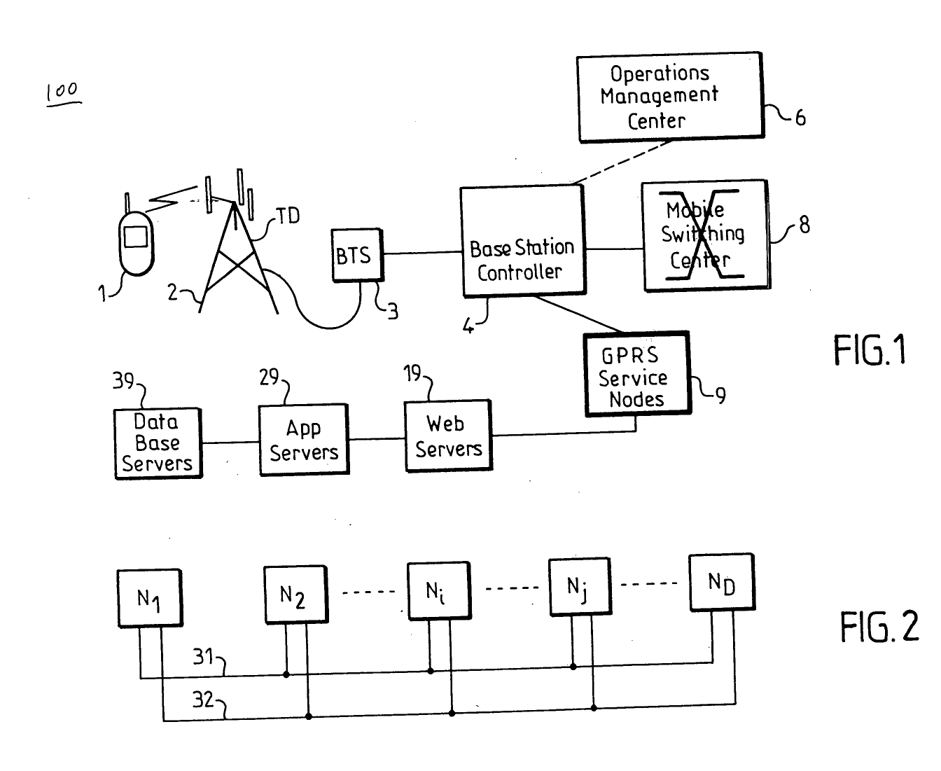

FIG. 1 illustrates a general diagram of a telecommunication network system 100 upon which embodiments in accordance with the invention may be implemented. Data transmission device 1 transmits data to terminal device 2 (TD). Terminal device 2 is operable to transmit data (e.g. connection request data) to base transmission station 3 (BTS). In one embodiment, base transmission station 3 gives access to a communication network, under control of a base station controller 4 (BSC). Base station controller 4 comprises communication nodes that support communication services (e.g., applications). In one embodiment, base station controller 4 also uses a mobile switching center 8 (MSC) adapted to orientate data to a desired communication service (or node), and further service General Packet Radio Service 9 (GPRS), giving access to network services, such as Web servers 19, application servers 29, data base server 39. Base station controller 4 is managed by an operation management center 6 (OMC).

In one embodiment, certain items in telecommunication network system 100 may comprise one or more groups of nodes, or clusters, exchanging data through two or more redundant networks. For example, base station controllers 4 may comprise one or more groups of nodes for exchanging data through two or more redundant networks. It should be appreciated that other components of telecommunication network system 100 may have a similar organization for exchanging data through two or more redundant networks.

FIG. 2 illustrates block diagram of a group of stations or nodes interconnected through two different links, in accordance with an embodiment of the present invention. FIG. 2 shows a cluster having D nodes (e.g., nodes N₁, N₂, through N_{D}) interconnected through two different links (e.g., link 31 and link 32). In the foregoing description, Nᵢ and Nⱼ designate two nodes, with i and j being comprised between 1 and D, inclusively. In one embodiment, links 31 and 32 as used may be high-speed network channels with equivalent bandwidth and latency. However, it should be appreciated that other channels may be also used (e.g. heterogeneous networks). For example, links 31 and 32 may be arranged as Ethernet physical networks. Other links may be possible such over Asynchronous Transfer Mode (ATM) or faster links such as InfiniBand.

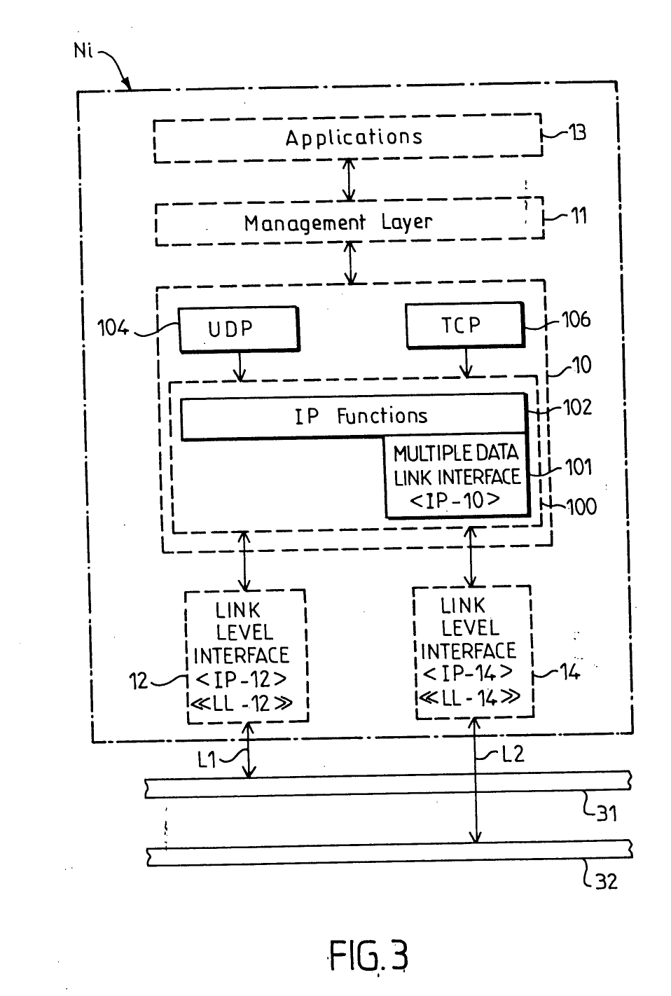

FIG. 3 is a block diagram of an exemplary node Nᵢ upon which embodiments in accordance with the invention may be implemented. Node Nᵢ comprises applications 13, management layer 11, network protocol stack 10, and link level interfaces 12 and 14, respectively interacting with network links 31 and 32 (also shown in FIG. 2). For purposes of the present application, node Nᵢ is part of the Internet, where a portion of its Internet address may uniquely define node Nᵢ. However, it should be appreciated that node Nᵢ may be part of a local or global network. Accordingly, as used hereinafter, “Internet address” or “IP address” refers to an address uniquely designating a node in the network being considered (e.g. a cluster) for whichever network protocol being used. Although the Internet is convenient at present, there is no restriction to the Internet.

In one embodiment, network protocol stack 10 comprises Internet interface 100 having conventional Internet protocol (IP) functions 102 and a multiple data link interface 101, and message protocol processing functions above Internet interface 100. Message protocol processing functions may comprise User Datagram Protocol (UDP) function 104 and/or Transmission Control Protocol (TCP) function 106.

Network protocol stack 10 is interconnected with the physical networks through link level interfaces 12 and 14, respectively. Link level interfaces 12 and 14 are interconnected to network links 31 and 32, via couplings Ll and L2, respectively. It should be appreciated that more than two channels may be provided, enabling work on more than two copies of a packet.

Link level interface 12 has an Internet address <IP_{—}12> and a Link level address <LL_{—}12>>. For purposes of the present application, the doubled triangular brackets (<< . . . >>) are used only to distinguish link level addresses from Internet addresses. Similarly, link level interface 14 has an Internet address <IP_{—}14> and a Link level address <LL_{—}14>>. In one embodiment, where the physical network is Ethernet-based, link interfaces 12 and 14 are Ethernet interfaces, and <<LL_{—}12>> and <LL_{—}14>> are Ethernet addresses.

IP functions 102 are operable to encapsulate a message received from an upper layer (e.g., UDP 104 or TCP 106) into a suitable IP packet format and, are operable to de-encapsulate a received packet before delivering the message it contains to UDP 104 or TCP 106.

In redundant operation, the interconnection between IP functions 102 and link level interfaces 12 and 14 occurs through multiple data link interface 101. Multiple data link interface 101 also includes an IP address <IP_{—}10>, which is the node address in a packet sent from source node Nᵢ. It should be appreciated that references to Internet and Ethernet are exemplary, and other protocols may also be used, both in network protocol stack 10, including multiple data link interface 101, and/or in link level interfaces 12 and 14. In another embodiment, where no redundancy is required, IP functions 102 may directly exchange messages with link level interface 12 or link level interface 14, thus bypassing multiple data link interface 101.

When circulating on any of network links 31 and 32, a packet may include several layers of headers in its frame. For example, a packet may include encapsulated within each other a transport protocol header, an IP header, and a link-level header.

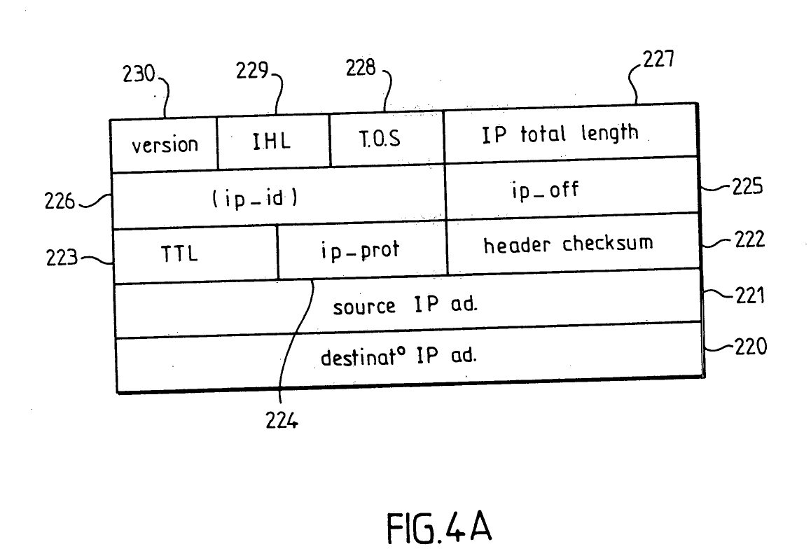

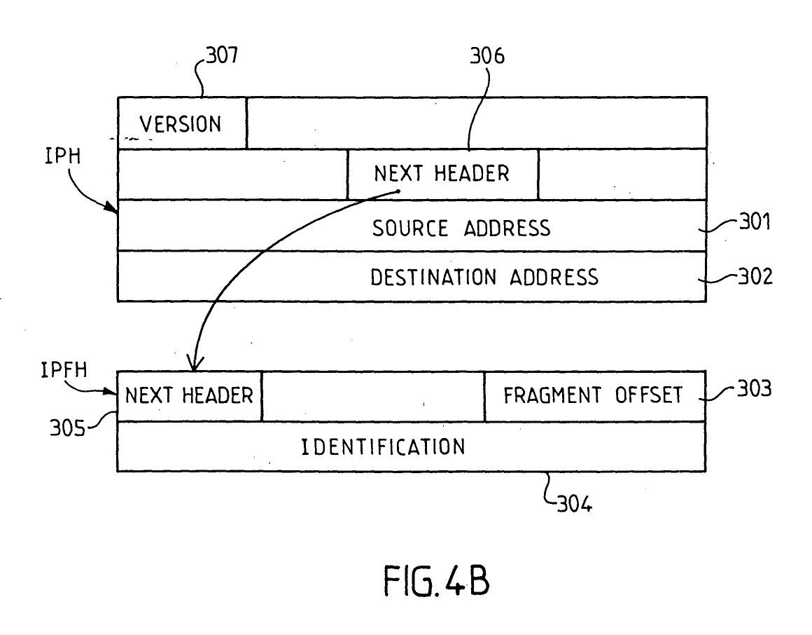

FIG. 4A illustrates an exemplary format of an IPv4 header in a packet in accordance with an embodiment of the present invention. As shown in FIG. 4A, an IPv4 header may comprise the following fields:

destination IP address 220;

source IP address 221;

header checksum 222;

Time To Live (TTL) 223;

protocol identifier (IP_PROT) 224;

zone 225 comprising fragmentation flags and fragment offsets (IP_OFF);

IP identification (IP_ID) 226;

IP total length 227;

type of service (T.O.S.) 228;

Header Length (IHL) 229; and

version identifier 230 for identifying a protocol (e.g., Internet protocol version 4 (IPv4)).

Certain of the fields illustrated in FIG. 4A are defined at the level of network protocol stack 10. For a packet corresponding to a complete data message, fields 220, 221, 224 and 226 are sufficient to identify the data message. In another embodiment, a data message may be split into a plurality of fragments sent through different packets. In the present embodiment, a packet corresponding to a fragment of a data message will have its field 225 completed with an indication of the position of the fragment in the data message. The remaining fields are service fields. For example, field 223 (TTL) determines the time after which the packet may be destructed.

FIG. 4B illustrates an exemplary format of an IPv6 header in a packet in accordance with an embodiment of the present invention. As shown in FIG. 4B, and IPv6 header may comprise the following fields:

destination IP address 302;

source IP address 301;

version identifier 307 for identifying a protocol (e.g., Internet protocol version 6 (IPv6)).

next header 306 designating a fragmentation header; and

other fields which do not identify a packet.

A fragmentation header IPFH is insert with the IP header IPH in order to identify the packet. The field next header 306 provides a link with the fragmentation header IPFH having the following fields:

next header 305 to designate another IPv6 header (if any);

IPv6 fragment identifier 304;

zone 303 including fragmentation flags and fragment offsets.

For purposes of the present application, “packet header” refers to information attached to a packet and indicating the source, the destination, and other service information for versions IPv4 and IPv6.

The identification field (e.g., field 226 of FIG. 4A or field 304 of FIG. 4B) is adapted to provide a different number for each different packet having the same other fields. By way of example only, the field 226 is 16 bits wide for the IPv4 version, and is thus able to provide 65,536 different numbers and thus 65,536 different packet headers. Then, the same numbers are reused. Thus, the packet is valid during a given period of time. A filtering time period may be defined according to the time for a source node to send a given number of packets. This given number of packets may depend upon the number of different packet headers a source may provide. This notion will be hereinafter useful. With respect to the IPv6 version, the field 304 is 32 bits wide, and thus the filtering time period is higher than the IPv4 filtering time period.

FIG. 5 illustrates a flow chart showing steps in a process for packet transmission in redundant mode, in accordance with an embodiment of the present invention. In one embodiment, process 500 is carried out by processors and electrical components (e.g., a computer system) under the control of computer readable and computer executable instructions. Although specific steps are disclosed in process 500, such steps are exemplary. That is, the embodiments of the present invention are well suited to performing various other steps or variations of the steps recited in FIG. 5.

At block 500, network protocol stack 10 of node Nᵢ receives a packet Pₛ from application layer 13 through management layer 11. At block 502, packet Ps is encapsulated with an IP header, in which field 220 comprises the address of a destination node (e.g., the IP address IP_{—}10(j)) of the destination node Nⱼ in the cluster and in which field 221 comprises the address of the source node (e.g., the IP address IP_{—}10(i) of the current node Nᵢ. It should be appreciated that both addresses IP_{—}10(i) and IP_{—}10(j) may be “intra-cluster” addresses, defined within the local cluster (e.g. restricted to the portion of a full address that is sufficient to uniquely identify each node in the cluster).

At block 504, link paths and addresses are determined. In one embodiment, at protocol stack 10, multiple data link interface 101 has data operable to define two or more different link paths for the packet. Such data may comprise:

a routing table, which contains information enabling to reach IP address IP_{—}10(j) using at least two different routes to Nⱼ, going respectively through distant interfaces IP_{—}12(j) and IP_{—}14(j) of node Nⱼ;

link level decision mechanisms for determining the way these routes pass through local interfaces IP_{—}12(i) and IP_{—}14(i), respectively; and

an address resolution protocol (ARP) may be used to make the correspondence between the IP address of a link level interface and its link level (e.g. Ethernet) address.

At block 506, packet Pₛ is duplicated into at least two copies Pₛ₁ and Pₛ₂. The copies Pₛ₁ and Pₛ₂ of packet Pₛ may be elaborated within network protocol stack 10, either from the beginning (IP header encapsulation), or at the time the packet copies will need to have different encapsulation, or in between. Each copy Pₛ₁ and Pₛ₂ of packet Pₛ now receives a respective link level header or link level encapsulation. Copy Pₛ₁ is sent to link level interface 12, as shown at block 511, and copy Pₛ₂ is sent to link level interface 14, as shown at block 512, as determined by the above mentioned address resolution protocol.

In one embodiment, multiple data link interface 101 in protocol stack 10 can prepare a first packet copy Pₛ₁, as shown at block 511, having the link level destination address LL_{—}12(j), and can send it through link level interface 12 having the link level source address LL_{—}12(i). Similarly, at block 512, another packet copy Pₛ₂ is provided with a link level header containing the link level destination address LL_{—}14(j), and can be sent through link level interface 14 having the link level source address LL_{—}14(i).

On the reception side, several copies of a packet, now denoted as Pₐ, should be received from the network in node Nⱼ. The first arriving copy is denoted Pₐ₁ with the other copy denoted as Pₐ₂, and also termed “redundant” packet(s), to reflect the fact that they bring no new information.

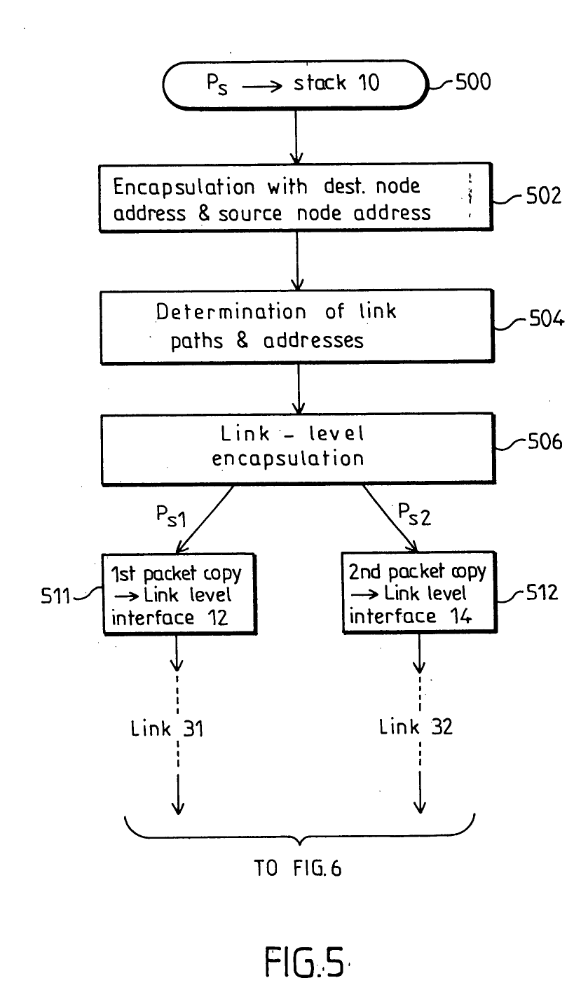

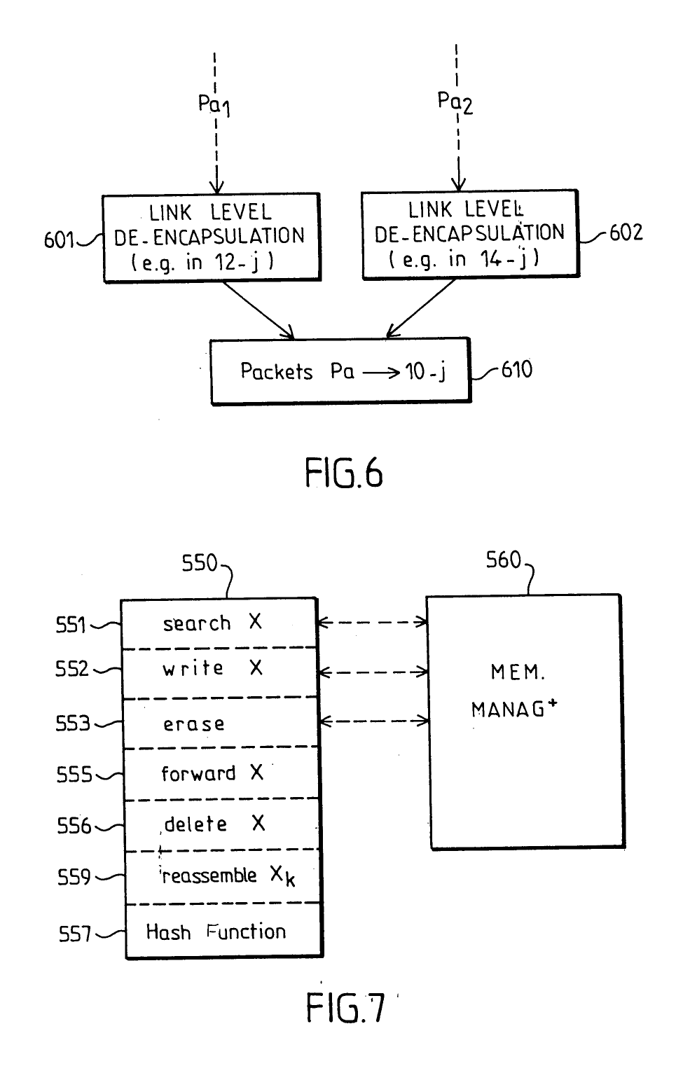

FIG. 6 illustrates a flowchart showing steps in a process for reception of redundant packets, in accordance with an embodiment of the present invention. In one embodiment, process 600 is carried out by processors and electrical components (e.g., a computer system) under the control of computer readable and computer executable instructions. Although specific steps are disclosed in process 600, such steps are exemplary. That is, the embodiments of the present invention are well suited to performing various other steps or variations of the steps recited in FIG. 6.

As shown in FIG. 6, one copy Pₐ₁ arrives through link level interface 12 (e.g., 12_{—}j) that, as shown at block 601, de-encapsulates the packet, thereby removing the link level header and address. The de-encapsulated packet Pₐ₁ is passed on to protocol stack 10 (e.g., 10_{—}j), as shown at block 610. Similarly, an additional copy Pₐ₂ arrives through link level interface 14 (e.g., 14_{—}j) that, as shown at block 602, de-encapsulate the packet, thereby removing the link level header and address. The de-encapsulated packet Pₐ₂ is passed on to protocol stack 10 (e.g., 10_{—}j) as shown at block 610.

Thus, protocol stack 610 normally receives two identical copies of the IP packet Pₐ, within the flow of other packets. Embodiments of the present invention provide for discriminating between a first incoming packet Pₐ₁ and one or more redundant following packets Pₐ₂, and for filtering the packet data. The filtering will depend upon whether a message is fragmented between several packets or whether such a fragmentation is authorized. Since the ultimate purpose is typically filtering, the word “filtering”, as used herein, may encompass both discriminating and filtering. It should however be kept in mind that “discriminating” is the basic function.

It should now be recalled that, amongst various transport Internet protocols, the message uses TCP when passing through TCP function 106. TCP has its own capability to suppress redundant packets but may cause long or unpredictable delays. The message uses UDP when passing through UDP function 104. UDP relies on an application's capability to suppress redundant packets, in the case of redundancy. This suppression of redundant packets may also be long and resource consuming.

In one embodiment, incoming packet copies have an IP header as described in FIGS. 4A and 4B. The transport protocol (e.g., TCP, UDP, or others) being used for a packet is specified in IP header (e.g., field 224 of FIG. 4A), or may be specified in a separate transport protocol header. Embodiments of the present invention may be viewed as providing, at reception side, a filtering function that operates independently of the transport or Internet protocol being used (e.g., TCP or UDP in the case of Internet). Embodiments of the present invention are also compatible with existing transport protocols. The built-in TCP processing of redundant packets may be kept as a function. Also, in case of UDP, the processing of redundant packets by user applications may also be kept as a function. In one embodiment, the filtering function is operable as described in PCT publication, Patent Number WO03013102, entitled “Filtering Redundant Packets in Computer Network Equipments,” with publication date Feb. 13, 2003, by Christophe Reiss, and assigned to the assignee of the present application.

Thus, network protocol stack 10 comprises a filtering function to detect and reject redundant packets. The filtering function may be located in multi data link interface 101, in IP functions 102, or in a distinct function module. In accordance with an aspect of this invention, information contained in the IP headers of packets can be used for discriminating packets when they arrive to network protocol stack 10. In one embodiment, this information is used to build distinctive identifiers, also referred to as “footprints,” of the incoming packets.

FIG. 7 illustrates the structure of an exemplary filtering function, in accordance with an embodiment of the present invention. As shown in FIG. 7, the filtering function uses memory manager 560 having a memory area, and an incoming packet manager 550 comprising a set of associated (e.g., filtering) functions.

In one embodiment, the memory area of memory manager 560 is reserved statically for the filtering functions by a central processing unit (not shown) of the node. In another embodiment, the memory area is reserved dynamically (e.g. where the time needed for memory allocation is not crucial).

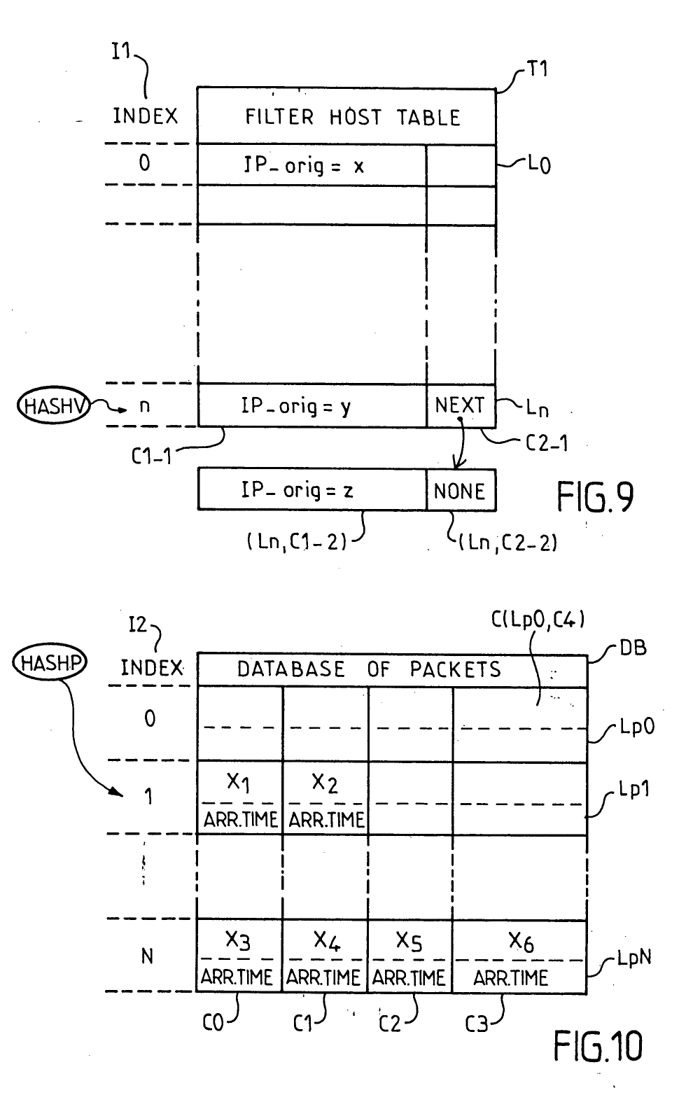

Memory manager 560 may divide its memory area into portions of memory reserved statically at initialization time and which may be allocated and released dynamically and individually. However, portions of memory may also be reserved dynamically, for example, when new routes are added in the routing table. These portions of memory are used to store the above-mentioned distinctive identifiers or footprints. In the example of a database of FIG. 10, the term “portion of memory” refers to a line of the database which may be designated with a line index. A line of the database is referred to as a “portion of database”. In the example of the table in FIG. 9, the term “portion of memory” refers to a line of the table and to parts of memory linked to this line as described hereinafter. The table of FIG. 9 may be sized and filled mostly at the initialization time. The term “portion of memory” may also designate other elements.

The filtering functions operable at incoming packet manager 550 may comprise:

search( ) 551—a function which searches for a footprint in at least a portion of the memory area of memory manager 560;

write( ) 552—a function which writes a footprint in the memory area;

erase( ) 553—a function which releases a portion of the memory area;

forward( ) 555—a function for sending a packet to the upper layers;

delete( ) 556—a function deleting or throwing away a packet; and

reassemble( ) 559—a function for gathering and reordering the fragments before they are forwarded to the upper layers when the message is complete (e.g., if it is desired to process message fragments).

It should be noted that at least functions 551, 552 and 553 interact with memory area 560.

In one embodiment, the present invention may be implemented by using software code, in which the memory area is represented by memory manager 560 and is capable of cooperating with memory hardware existing in the node for reserving a memory area. Defined in the memory area are a database and a set pf portions of memory. In one embodiment, the database (e.g., the database as described in FIG. 10) comprises a set of portions of a database, each portion being designated with an index value. In one embodiment, at least one portion of memory (e.g., the table as described in FIG. 9) is designated with an index value. Additionally, incoming packet manager 550 contains at least some of the filtering functions (e.g., functions 551, 552, 553, 555, 556 and 559), depending upon the desired implementation. Moreover, incoming packet manager 550 may also be adapted to execute the operations of a filtering method of the invention.

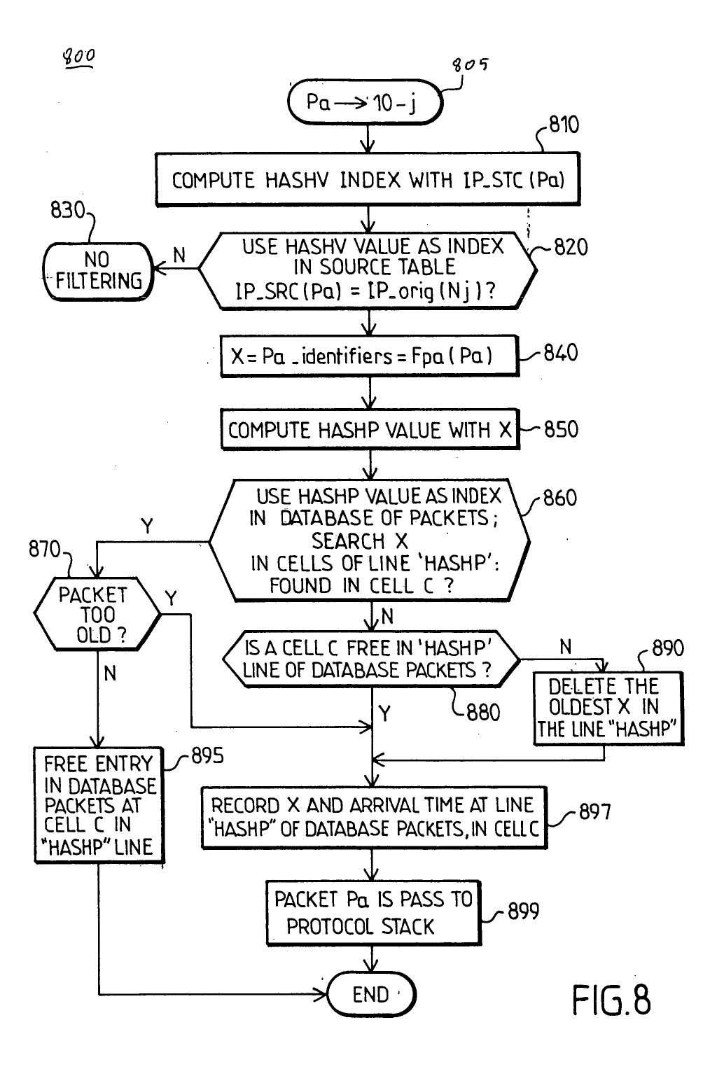

FIG. 8 illustrates a flow chart showing steps of a process 800 for discriminating of received packets, in accordance with an embodiment of the present invention. In one embodiment, process 600 is carried out by processors and electrical components (e.g., a computer system) under the control of computer readable and computer executable instructions. Although specific steps are disclosed in process 600, such steps are exemplary. That is, the embodiments of the present invention are well suited to performing various other steps or variations of the steps recited in FIG. 6.

At block 805, an IP packet (Pₐ) reaches protocol stack 10 of its final destination node Nⱼ. At block 810, the arriving IP packet comprises a source address IP-src(Pₐ) for which a value is computed. The value is a first hash value denoted Hashv and is computed from the source address using a hash function (e.g., hash function 557 of FIG. 7) of incoming packet manager 550. A source list defines all the source IP addresses (IP-orig) for which memory manager 560 filters the packets. The source list may be a table comprising several lines (e.g., n+1 lines with n being an integer), each being designated with an index. Index values and hashv values may be integers in the value interval [0, n]. A line index corresponds to the hashv value of the source IP address. Several source IP addresses can also have the same hashv value as hereinafter described in FIG. 9. Thus, in the line designated with the index matching the hashv value, at block 820, it is determined whether the source IP address (IP-src) of packet Pₐ matches the source IP address or one of the source IP addresses (IP-orig) stored in this line. This last checking is useful as the hash function may compute an identical value for several different addresses, referred to herein as a collision. In one embodiment, the hashv function is a CRC Hash function as described in Knuth, D., The Art of Computer Programming, Volume 2: Semi-numerical Methods, Chapter 5, Addison Wesley, 1981.

For example, the addresses (including the “intra-cluster” addresses) of all the nodes in the cluster may be in the source list. In one embodiment, the source list excludes the local node. In another embodiment, the source list may also be restricted to those of the nodes in the cluster that are currently in operation.

If the node IP address (IP-src) is not stored in the line having the appropriated index, as shown at block 830, no filtering is done for the IP packet. For example, the packet may be subject to normal processing through conventional IP functions 102. Alternatively, process 800 continues at block 840.

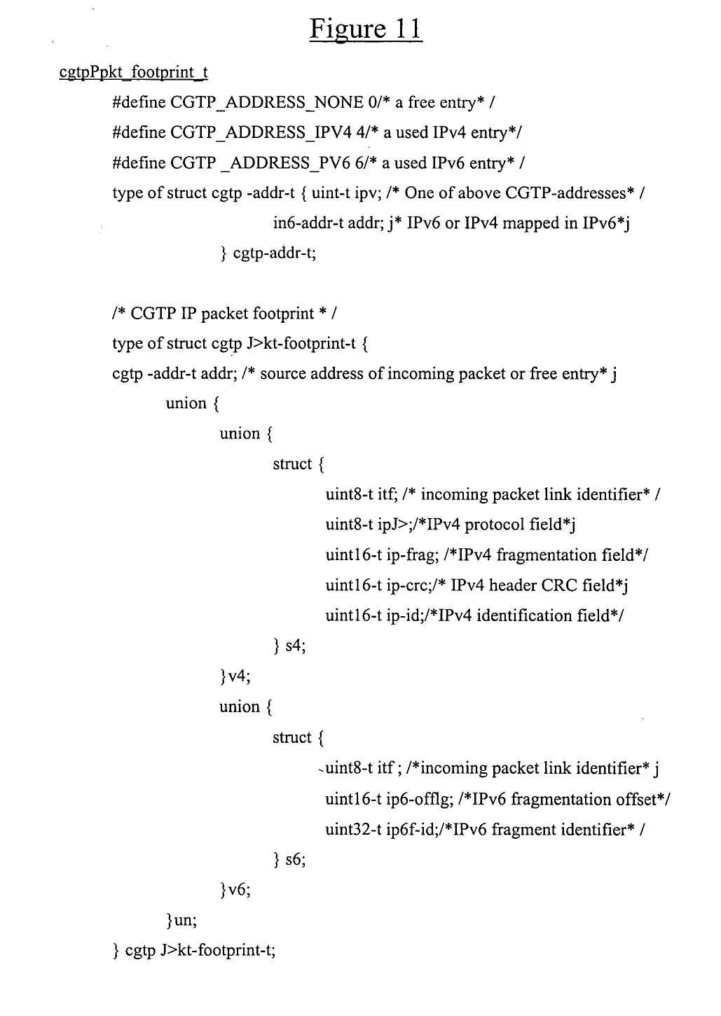

At block 840, a value X is computed for the incoming packet. As described hereinafter, this value comprises a union of data or fields concerning the packet. Structure cgtp-pkt-footprint-t of FIG. 11 is an example of data structure used to represent a packet identifier X. Thus, one of these fields represents the incoming packet link named itf field. In one embodiment, first incoming packet Pₐ₁ and its redundant packets Pₐ₂ have the same value of X, except for the itf field. Although it is generally qualified as a distinctive packet identifier, this value X is referred to as a footprint or an identifier hereinafter for purposes of simplification.

Although the identifier X may be used for a research in the memory area of memory manager 560, a hash value is computed with a hash function called hashp using the identifier X, as shown at block 850. This hash value is denoted hashp value. This hash function may compute hashp using all of the bits of a packet footprint X. In one embodiment, the hashp function is a function of the minimal perfect hashing that is well-known in the art.

To detect duplicated packets, a history of the incoming packets already received is continuously maintained. The memory area of memory manager 560 comprises a database organized in N+1 lines and M+1 columns, N and M being integers. Each line is designated with a line index. Index values and hashp values may be integers in the value interval [0, N]. The intersection of a line and a column is denoted a cell C: a line is composed of M+1 cells. A line index corresponds to the hashp value of the identifier X of an incoming packet. In a given line, each cell may comprise a footprint X of a packet having the hashp value. As several incoming packets may have the same hashp value, several cells (and columns, respectively) are forecast for a line (and lines, respectively). Cells (and columns, respectively) are thus used in case of hash collision if the hash function does not avoid entirely collisions.

At block 860, the identifier X of the incoming packet Pa is searched in the cells of the line designated with an index corresponding to the hashp value. If this identifier X is comprised in one cell C of the line, process 800 continues at operation 870. Otherwise, process 800 continues at operation 880.

In the database, the identifier X is recorded with its arrival time, wherein the arrival time is the current time at the time it is recorded. A time period indicates the validity period for a recorded identifier X. The age of the identifier X is computed by comparing the current time and its stored arrival time. If this age is greater than the time period, then the recorded identifier X of its corresponding incoming packet is considered to be too old, and it is considered invalid.

At block 870, as the identifier X has been found in a cell of the line, it is checked if the recorded identifier X is not too old. If it is, the new identifier X is recorded with its current arrival time, as shown at block 897, in the same cell of the line. If it is not too old, as shown at block 895, the new incoming packet is considered to be a redundant packet so the cell in the line may be liberated in the database for other incoming packets. Thus, any redundant packets which arrive during the time period of the source node make room in a line.

At block 880, it is determined if a cell remains free in the line having the index corresponding to the hashp value. If no cell remains free, a cell is chosen in the line, this cell having the oldest identifier X in the line. This oldest identifier is deleted, as shown at block 890. The identifier X of the incoming packet is then recorded in this cell with its arrival time, as shown at block 897. After operation 897, the incoming packet is not redundant and is passed to the protocol stack, as shown at block 899.

The arrival time may be understood as the current time at which an operation is done for the incoming packet, for example the current time at which the identifier X of the incoming packet is recorded (qualified as the stored arrival time) or the current time at which the comparison between the age of the stored identifier X and the time period is done (qualified as the current arrival time). The use of the hashp index means as few comparisons as possible are required for the search in the database.

FIG. 11 illustrates an exemplary data structure, in accordance with an embodiment of the present invention. In particular, FIG. 11 illustrates an example of the footprint X computation. IPv4 entry, IPv6 entry and free entry of packets are all defined in lines 1 to 3. The source address of the incoming packet is mapped as an IPv6 source address structure (lines 4 to 6). Computation of the footprint X begins line 7. The source address of the incoming packet (field 221 of FIG. 4A or field 301 FIG. 4B) is added to a first union of different fields of the incoming packet header (for the IPv4 version) or a second union of different fields of the incoming packet header (for the IPv6 version). The first union comprises field 224 (line 13), field 225 (line 14), field 222 (line 15) and field 226 (line 16) of FIG. 4A and the second union comprises field 303 (line 22) and field 304 (line 23) of FIG. 4B.

A time period may differ for each source node and may be adapted or updated dynamically according to the input packet rate of each source node. At start time, this period called ip_cgtp_filter_period is only an initial period associated to each source node recorded in the filter. Then, if one source node emits packets in a faster way than other source nodes, or if faster networks are used for some source nodes, the period per source node can be lowered dynamically. The incoming packet manager may customize a time period for packets that have the same source address.

The database size may be defined by the number of lines (ip_cgtp_filter_pkt_lines) and the number of columns (ip_cgtp_filter_pkt_collisions). For performance reasons of the IP packet hash function, the number of lines may be a power of two. For example, Ip_cgtp_filter_pkt_lines=16384 and ip_cgtp_filter_pkt_collisions=3 will allow up to (16384*(3+1))=65536 IP packets to be recorded.

The way to compute footprint X is chosen, in combination with the internal structure of memory area of memory manager 560, to reduce the risk of the two packets Pₐ not being redundant of each other to have the same footprint X. It should be understood that the database comprises portions of memory, allocated by memory manager 560 within the memory area reserved to it.

FIG. 9 illustrates a source node table T1 (also referred to as a filter host table) of a receiving node in accordance with an embodiment of the present invention. Table T1 comprises all the source IP addresses of nodes whose emitted packets have to be filtered by the receiving node. Table T1 comprises n+1 lines L₀ to Lₙ, each designated with a different integer index I1 comprised in the value interval [0,n]. Table T1 also comprises a first column C1-1 for first IP-orig addresses of source nodes for which filtering is required. A zone defines a zone memory comprising node information data such as an IP-orig address in the filter host table of FIG. 9 and the input packet rate of the source node corresponding to this IP-orig address. For example, the IP-orig=x is in the zone (L₀; C1-1) meaning the corresponding hashv value is 0 and the IP-orig=y is in the zone (Lₙ, C1-1) meaning the hashv value is n. Table T1 further comprises a second column C2-1 in which, for each line a first portion of memory is designated for the same line index. The first portion of memory may comprise an IP-orig address having the same hashv value as the IP-orig address in column Cl-l. For example, the zone (Ln, C2-1) designates a portion of memory comprising a first and second zone (Ln, C1-2) and (L1, C2-2) for an IP address having the same hashv value as the line index n. The first zone (Lₙ, C1-2) comprises the IP-orig=z address, its hashv value being n. The second zone (Lₙ, C2-2) is adapted to designate, for the same index n, a second portion of memory (also referred to as the next portion of memory). The second portion of memory may also comprise a first and second zone similar to the first portion of memory. The hashv value is computed with a hash function as seen using the source IP address and corresponds to an index in table T1. The advantage of such hashv value is a faster search in table T1 to retrieve the source IP address.

FIG. 10 illustrates an exemplary database DB of a receiving node in accordance with an embodiment of the present invention. Database DB comprises the received footprints of incoming packets of source nodes of table T1. Database DB is comprised of N+1 lines Lpj and M+l columns Ci. Each line is designated with its line index I2 whose value is in the value interval [0, N]. Each hashp value of an incoming packet may correspond to one of these different indexes. These indexes enable faster search in the database. The line having its index=1 in the database is now described. Each cell of this line is adapted to comprise the footprint and the arrival time of an incoming packet having its hashp value=1. Cell (Lp1, C1) comprises the identifier X1 and its arrival time, cell (Lp1, C2) comprises the identifier X2 and its arrival time. In the case of hashp value collision with incoming packets, cells (Lp1, C3) and (Lp1, C4) are disposable to receive identifiers different from the recorded footprint X1 and X2. If no such footprint has been recorded yet, the footprint and its arrival time are recorded in the other columns of the same line.

Embodiments of the present invention enable a single database to handle redundancy of all packets of all source nodes requiring filtering. Moreover, the use of hash values corresponding to indexes in the table and in the database improves the search speed for source address and footprint.

However, it should be appreciated that the present invention is not limited to the hereinabove described embodiments. Other version of packets may be used and adapted to be handled as packets to be filtered, and other hash functions may also be used.

Embodiments of the present invention also cover the software code for performing the method, especially when made available on any appropriate computer-readable medium. It should be appreciated that a computer-readable medium may include a storage medium such as magnetic or optic disk, as well as a transmission medium such as a digital or analog signal. The software code includes, separately or together, the codes defining the memory manager 560, the packet manager 550, and the codes for implementing at least partially the flow-charts of FIGS. 5, 6 and 8.

While the present invention has been described in particular embodiments, it should be appreciated that the present invention should not be construed as limited by such embodiments, but rather construed according to the following claims.

What is claimed is:

1. A method for processing redundant packets, said method comprising:
receiving an incoming packet comprising a source address and data;
searching for said source address of said incoming packet in at least a portion of memory;
provided said source address is found in said portion of memory, determining a packet identifier based on said data comprised in said incoming packet,
searching for said packet identifier in at least a portion of a database; and
provided said packet identifier is not found in said portion of said database, storing said packet identifier in said portion of said database.

2. The method as recited in claim 1 further comprising determining whether a time condition for said incoming packet is satisfied.

3. The method as recited in claim 2 further comprising:
provided said packet identifier is found in said portion of said database and said time condition is satisfied, identifying said incoming packet as a redundant packet; and
removing said packet identifier from said portion of said database.

4. The method as recited in claim 2 further comprising, provided said packet identifier is found in said portion of said database and said time condition is not satisfied, storing said packet identifier in said portion of said database.

5. The method as recited in claim 2 further comprising:
storing said packet identifier in said portion of said database; and
storing an arrival time of said incoming packet in said portion of said database.

6. The method as recited in claim 5, wherein determining whether said time condition is satisfied comprises:
comparing a current time with said arrival time to determine an age of said packet identifier; and
comparing said age to a given time period in order to determine if said time condition is satisfied.

7. The method as recited in claim 6, wherein said comparing said age to said given time period comprises:
determining that said time condition is satisfied if said age is greater than said given time period;
removing said packet identifier and said arrival time; and
replacing said packet identifier with a new packet identifier of said incoming packet and replacing said arrival time with a new arrival time associated with said incoming packet

8. The method as recited in claim 7 further comprising customizing said time period for incoming packets comprising the same source address.

9. The method as recited in claim 8 further comprising updating said time period associated with a source according to the rate of incoming packets from said source.

10. The method as recited in claim 1 further comprising determining a first value based on said packet identifier.

11. The method as recited in claim 10, wherein said determining said first value comprises using a hash function for determining said first value.

12. The method as recited in claim 1, wherein said storing said packet identifier in said portion of said database further comprises:
provided said portion is full of other packet identifiers, comparing current time with stored arrival times corresponding to said other packet identifiers to determine ages of said packet identifiers;
determining an oldest packet identifier of said other packet identifiers; and
deleting said oldest packet identifier and its corresponding arrival time.

13. A system for filtering redundant packets, said system comprising:
a memory manager comprising a reserved memory area, said reserved memory area comprising:
at least one portion of memory comprising at least a source address; and
a database, wherein at least one portion of said database comprises at least one index value associated with a packet identifier; and
an incoming packet manager operable to receive an incoming packet comprising a source address, search said portion of memory for said source address of said incoming packet, determine a packet identifier of said incoming packet if said source address of said incoming packet is found, determine an index value based on said packet identifier of said incoming packet, search said database for said index value of said incoming packet, and store said packet identifier of said incoming packet in said database if said index value of said incoming packet is not found.

14. The system as recited in claim 13 wherein said incoming packet manager is also operable to determine whether a time condition for said incoming packet is satisfied.

15. The system as recited in claim 14 wherein said incoming packet manager is also operable to identify said incoming packet as a redundant packet if said index value of said incoming packet is found in said database and said time condition is satisfied and to remove said packet identifier from said database.

16. The system as recited in claim 14 wherein said incoming packet manager is also operable to store said packet identifier of said incoming packet in said database if said index value of said incoming packet is found in said database and said time condition is not satisfied.

17. The system as recited in claim 14 wherein said incoming packet identifier is also operable to store said packet identifier of said incoming packet in said database and store an arrival time of said incoming packet in said database.

18. The system as recited in claim 17 wherein said incoming packet identifier is operable to determine whether said time condition is satisfied by comparing a current time with said arrival time to determine an age of said packet identifier and comparing said age to a given time period in order to determine if said time condition is satisfied.

19. The system as recited in claim 18 wherein said incoming packet identifier is operable to compare said age to said given time period by determining that said time condition is satisfied if said age is greater than said given time period, removing said packet identifier and said arrival time, and replacing said packet identifier with a new packet identifier of said incoming packet and replacing said arrival time with a new arrival time associated with said incoming packet.

20. The system as recited in claim 19 wherein said incoming packet identifier is also operable to customize said time period for incoming packets comprising the same source address.

21. The system as recited in claim 20 wherein said incoming packet identifier is also operable to update said time period associated with a source according to the rate of incoming packets from said source.

22. The system as recited in claim 13, wherein said index value is determined according to a hash function.

23. A computer-readable medium having computer-readable program code embodied therein for causing a computer system to perform a method for processing redundant packets, said method comprising:
receiving an incoming packet comprising a source address and data;
searching for said source address of said incoming packet in at least a portion of memory;
provided said source address is found in said portion of memory, determining a packet identifier based on said data comprised in said incoming packet,
searching for said packet identifier in at least a portion of a database; and
provided said packet identifier is not found in said portion of said database, storing said packet identifier in said portion of said database.

24. The computer-readable medium as recited in claim 23 further comprising determining whether a time condition for said incoming packet is satisfied.

25. The computer-readable medium as recited in claim 24 further comprising:
provided said packet identifier is found in said portion of said database and said time condition is satisfied, identifying said incoming packet as a redundant packet; and
removing said packet identifier from said portion of said database.

26. The computer-readable medium as recited in claim 24 further comprising, provided said packet identifier is found in said portion of said database and said time condition is not satisfied, storing said packet identifier in said portion of said database.

27. The computer-readable medium as recited in claim 24 further comprising:
storing said packet identifier in said portion of said database; and
storing an arrival time of said incoming packet in said portion of said database.

28. The computer-readable medium as recited in claim 27, wherein determining whether said time condition is satisfied comprises:
comparing a current time with said arrival time to determine an age of said packet identifier; and
comparing said age to a given time period in order to determine if said time condition is satisfied.

29. The computer-readable medium as recited in claim 28, wherein said comparing said age to said given time period comprises:
determining that said time condition is satisfied if said age is greater than said given time period;
removing said packet identifier and said arrival time; and
replacing said packet identifier with a new packet identifier of said incoming packet and replacing said arrival time with a new arrival time associated with said incoming packet

30. The computer-readable medium as recited in claim 29 further comprising customizing said time period for incoming packets comprising the same source address.

31. The computer-readable medium as recited in claim 30 further comprising updating said time period associated with a source according to the rate of incoming packets from said source.

32. The computer-readable medium as recited in claim 23 further comprising determining a first value based on said packet identifier.

33. The computer-readable medium as recited in claim 32, wherein said determining said first value comprises using a hash function for determining said first value.

34. The computer-readable medium as recited in claim 23, wherein said storing said packet identifier in said portion of said database further comprises:
provided said portion is full of other packet identifiers, comparing current time with stored arrival times corresponding to said other packet identifiers to determine ages of said packet identifiers;
determining an oldest packet identifier of said other packet identifiers; and
deleting said oldest packet identifier and its corresponding arrival time.
